(19) United States
(12) Patent Application Publication
(10) Pub. No.: US 2011/0221288 A1
(43) Pub. Date: Sep. 15, 2011

(54) SYSTEM AND METHOD FOR COOLING IN ELECTRIC MACHINES

(75) Inventors: Hendrik Pieter Jacobus de Bock, Clifton Park, NY (US); Ayman Mohamed Fawzi EL-Refaie, Niskayuna, NY (US); William Dwight Gerstler, Niskayuna, NY (US)

(73) Assignee: GENERAL ELECTRIC COMPANY, SCHENECTADY, NY (US)

(21) Appl. No.: 12/720,825

(22) Filed: Mar. 10, 2010

(51) Int. Cl. H02K 9/19; H02K 15/02

(52) U.S. Cl. 310/59; 29/596

(57) ABSTRACT

A segmented cooling system for an electric machine is provided. The segmented cooling system includes multiple cooling subsystems coupled to respective multiple stator segments in the electric machine, wherein the multiple cooling subsystems directs fluid flow towards one or more regions of interest within the respective multiple stator segments.

### BACKGROUND

The invention relates generally to electrical machines, such as electric generators and/or electric motors. Particularly, this invention relates to cooling in such electrical machines.

Electric machines such as, but not limited to, Interior Permanent Magnet, hereafter referred to as IPM, motors or generators have been widely used in a variety of applications including aircraft, automobiles and industrial usage. IPM machines are currently being developed for use in hybrid automotive applications. A demand for lightweight and high power density IPM machines has resulted in the design of higher speed motors and generators to maximize the power to weight ratios. Hence, the trend is increasing acceptance of IPM machines offering high machine speed, high power density, and reduced mass and cost.

Electric machines generally have a closed housing and a small air gap between the stator and the rotor. On three-phase machines of the known art, the housing is closed for maintenance reasons and is provided with fins on the outside to discharge heat. As the power of electrical machines increases, such cooling systems are no longer able to discharge a sufficient amount of heat.

Such a problem exists to a particular degree with drive axles in which one or more electrical machines are installed. As a result of which, the electrical machines reach high steady-state temperatures. In machines realized in the form of industrial trucks that are operated in multiple-shift operations, for example, thermal overloads can occur in the problem zones in the vicinity of the bearings and the sealing devices of the electrical machines. This can lead to the failure of the sealing devices or of the bearings. In comparison to air cooling systems, liquid cooling systems are significantly more efficient and make it possible to discharge a large amount of heat. So, to achieve the same power output, the size of the electrical machine can be reduced, or for an electrical machine of the same size, the power output can be increased.

On three-phase machines, liquid cooling systems are known in which a system of tubes to cool the stator is located on the outer jacket. However, an external cooling system to cool the entire three-phase machine is difficult and expensive to construct. Electrical machines with an internal liquid cooling system are also known in which the rotor runs under oil, although that causes increased churning losses.

Accordingly, there is a need for an improved cooling system for electrical machines.

### BRIEF DESCRIPTION

In accordance with an embodiment of the invention, a segmented cooling system for an electric machine is provided. The segmented cooling system includes multiple cooling subsystems coupled to respective multiple stator segments in the electric machine, wherein the multiple cooling subsystems are configured to direct fluid flow towards one or more regions of interest within the respective plurality of stator segments.

In accordance with another embodiment of the invention, an electric machine is provided. The electric machine includes a stator including multiple stator segments coupled to a respective multiple cooling subsystems; wherein the multiple cooling subsystems is configured to direct fluid flow towards one or more regions of interest within the respective multiple stator segments. The electric machine also includes a rotor including a rotor core, wherein the rotor is disposed concentrically either inside or outside of the stator.

In accordance with another embodiment of the invention, a method of assembly of an electric machine is provided. The method includes coupling multiple segmented cooling subsystems with each of a respective multiple stator segments to form multiple cooled stator segments. The method also includes attaching the multiple cooled stator segments to form a cooled stator assembly of the electric machine. The method further includes attaching the cooled stator assembly to a rotor assembly.

In accordance with yet another embodiment of the invention, a method for cooling regions of interest in an electric machine is provided. The method includes coupling multiple cooling subsystems with respective multiple stator segments in the electric machine. The method also includes directing fluid flow via the multiple cooling subsystems towards the regions of interest within the multiple stator segments.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic illustration of an exemplary electric machine including multiple cooling subsystems in accordance with an embodiment of the invention.

FIG. 2 is a side view of the electric machine in FIG. 1 including an exemplary segmented cooling subsystem in accordance with an embodiment of the invention.

FIG. 3 is a top view of the electric machine in FIG. 2.

FIG. 4 is a side view of the electric machine in FIG. 1 including a segmented impingement cooling subsystem in accordance with another embodiment of the invention.

FIG. 5 is a top view of the electric machine in FIG. 4.

FIG. 6 is a top view of the electrical machine in FIG. 1 including cooling channels between stator segments in accordance with an embodiment of the invention.

FIG. 7 is a front view of the electric machine in FIG. 6.

FIG. 8 is a top view of the electrical machine in FIG. 1 including cooling channels having at least one radial duct in accordance with an embodiment of the invention.

FIG. 9 is a front view of the electric machine in FIG. 8

FIG. 10 is a flow chart representing steps in a method of assembly of an electric machine including multiple cooling subsystems in accordance with an embodiment of the invention.

FIG. 11 is a flow chart representing steps in a method for cooling regions of interest in an electric machine in accordance with an embodiment of the invention.

### DETAILED DESCRIPTION

As discussed in detail below, embodiments of the invention include a system and method for cooling in electric machines. The system includes a segmented cooling system integrated within stator segments. As used herein, the term ‘segmented cooling system’ refers to individual cooling systems coupled to each of the stator segments in the electric machine. In one embodiment, the segmented cooling system includes baffles. In another embodiment, the segmented cooling system includes an impingement system. In yet another embodiment, the segmented cooling system may be introduced between the stator bars. Such a cooling arrangement enables pre-assembly of the stator segments and the cooling system and further linking of multiple such modules of stator segments and cooling systems to form an integrated stator. It should be noted that the cooling concepts described are applicable to all types of electrical machines with segmented stator structures and fractional-slot concentrated windings.

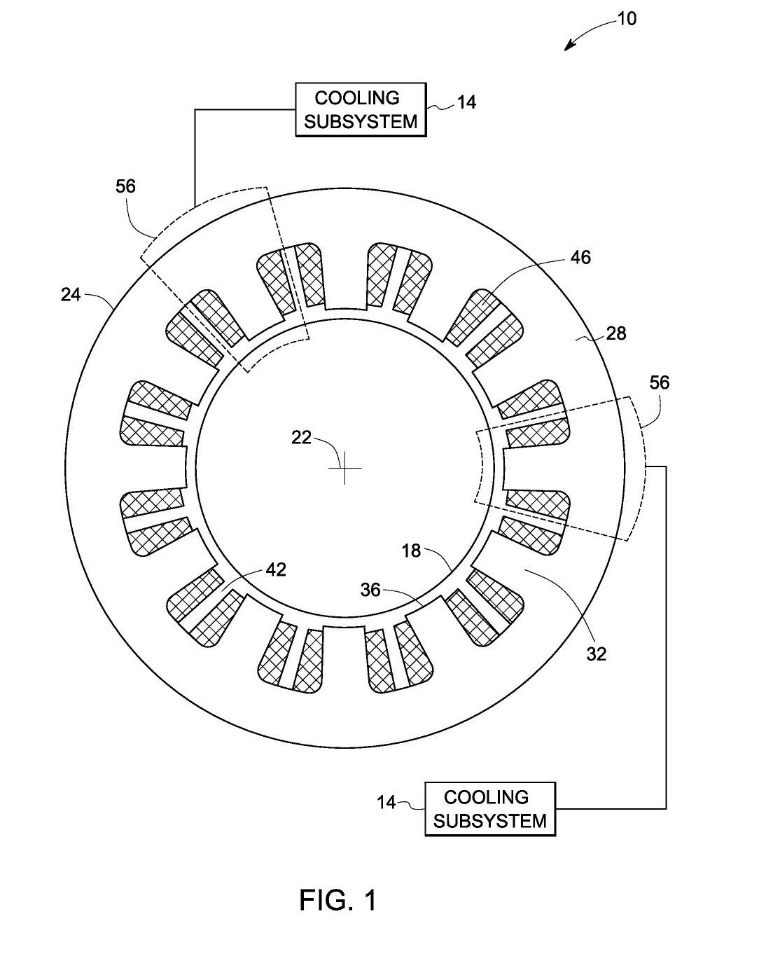

Turning to the drawings, FIG. 1 is a diagrammatic illustration of an exemplary electric machine 10 such as an electric motor or generator, for example. The electric machine 10 includes stator segments having respective segmented cooling subsystem 14. The electric machine 10 includes a rotor assembly 18 that is configured to rotate about a longitudinal axis 22. The electric machine 10 further includes a stator assembly 24 including a yoke or back iron 28 and stator teeth 32. The stator teeth 32 each include a tooth tip 36. The stator assembly 24 includes multiple stator slots 42 for concentrated windings 46, where the coil is wound around a stator tooth 32. The stator assembly 24 generates a magnetic field and extends along the longitudinal axis 22.

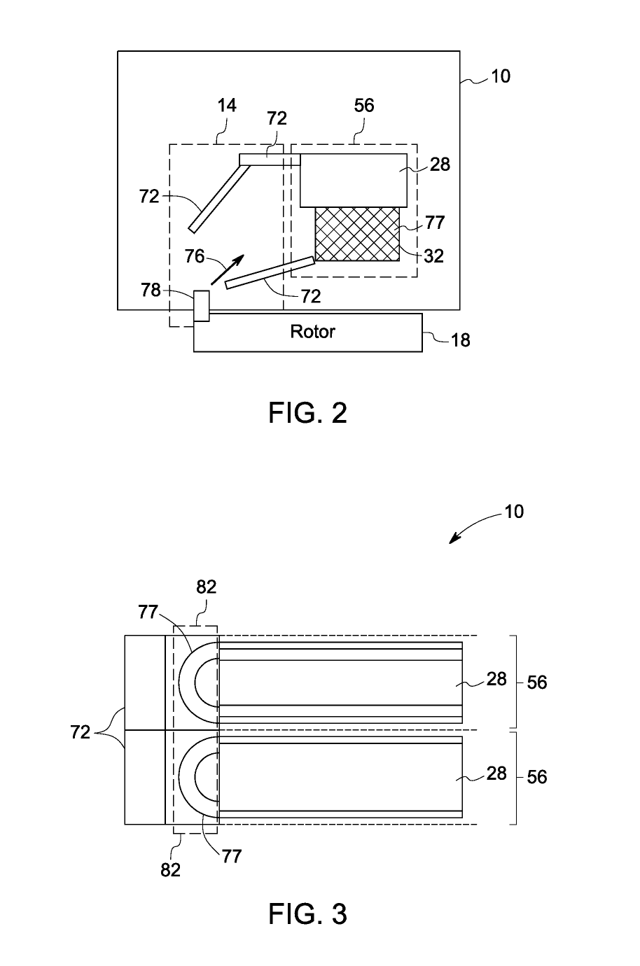

Each of the stator segments 56 are coupled to respective cooling subsytems 14. The cooling subsystems 14 may also be referred to as ‘segmented cooling subsytems’. The various embodiments of the segmented cooling subsystems 14 are described below in FIGS. 2-9.

The tooth tips 36 shown in the exemplary embodiments of the invention discussed herein show flared tooth tips, which are desirable for increasing machine power density. However, the tooth tips can have any shape or size suitable to the application. It should be noted that the segmented cooling subsystem 14 may be employed on other known configurations of the segmented stator assembly 56.

FIG. 2 is a side view of the electric machine 10 in FIG. 1 including an exemplary segmented cooling subsystem 14. In the illustrated embodiment, the segmented cooling subsystem 14 includes multiple segmented baffles 72 that direct flow 76 directly towards the stator segment 56 (FIG. 1) that includes the yoke 28 and endwindings 77. In an exemplary embodiment, the flow 76 is generated by, but not limited to, fan blade 78 disposed on the rotor assembly 18 (FIG. 1). The baffles 72 are attached to the stator segment 56 or a stator tooth 32 (FIG. 1) via a support structure (not shown). The segmented baffles 72 would facilitate easier assembly of the cooling system for the electric machine 10. It should be understood that the baffles 72 are oriented at optimal angles, depending upon location of the coolant source 78 such that the flow 76 is directed directly towards the stator segment 56 enabling optimal cooling. In another embodiment, a guide vane (not shown) may be employed to reduce a rotational circulation of the flow 76 and direct the airflow towards the stator segment 56. Although three baffles 72 have been illustrated, it will be appreciated that any number of baffles may be employed.

FIG. 3 is a top view of the electric machine 10 including the multiple segmented baffles 72 at a segmented endwinding region 82. As described above, the segmented baffles 72 direct flow towards endwindings 77 (FIG. 2) and the segmented stator assembly 56. In the illustrated embodiment, two such segments have been depicted.

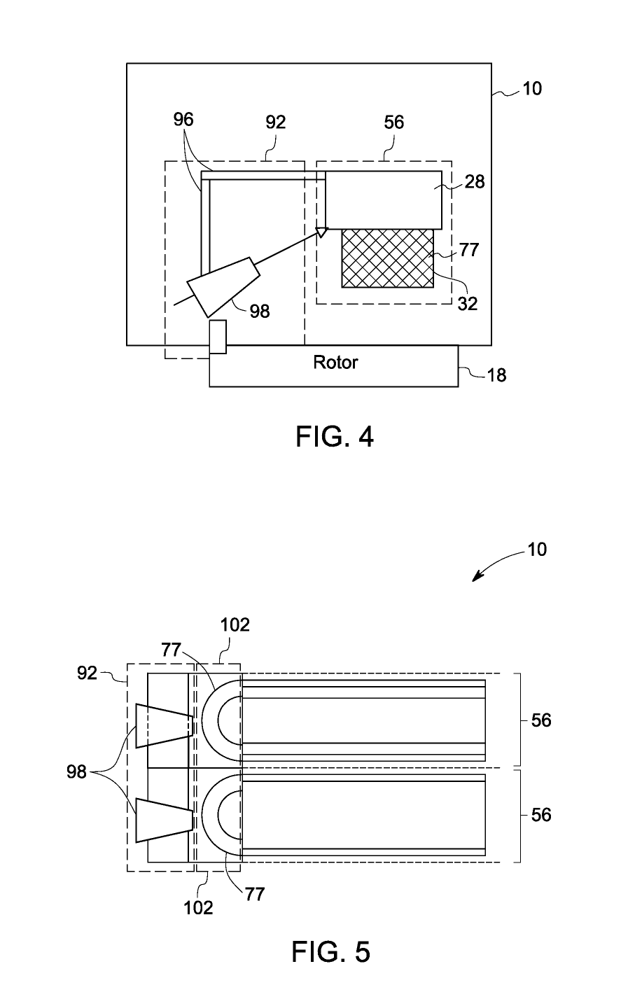

FIG. 4 is a side view of the electric machine 10 in FIG. 1 including another exemplary segmented cooling subsystem 14. In the illustrated embodiment, the segmented cooling subsystem 14 includes an impingement subsystem 92 that is coupled to the stator segment 56 (FIG. 1) via a support structure 96. The impingement subsystem 92 includes at least one impingement nozzle 98 that directs flow 98 on the stator segment 56. In one embodiment, the impingement nozzles guide the flow. In another embodiment, the impingement nozzle 98 may be coupled to a liquid source such as, for example, an oil source to provide liquid impingement. In such an embodiment, the nozzle 98 is connected to the liquid source via a hose. In another exemplary embodiment, a spray nozzle 98 may be employed, wherein the spray nozzle 98 atomizes the liquid from the liquid source and directs a mist on the stator segment 56. It will be appreciated that the impingement nozzle or spray nozzle 98 may be of different shapes and sizes. Non-limiting examples of a coolant fluid may include air and oil.

FIG. 5 is a top view of the electric machine 10 including the segmented impingement cooling subsystem 92 (FIG. 4) disposed at a segmented endwinding region 102. As described above, the segmented impingement nozzles or spray nozzles 98 direct flow towards endwindings 77 (FIG. 2) and the segmented stator assembly 56. In the illustrated embodiment, two such segments have been depicted.

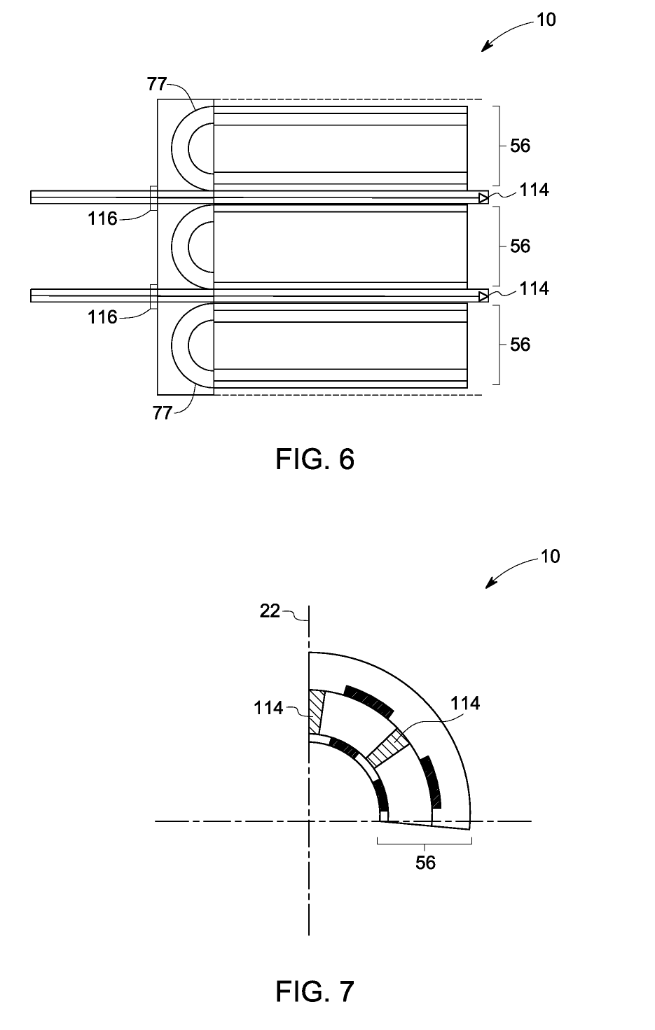

FIG. 6 is a top view of the electric machine 10 including a segmented cooling subsystem 112 attached to the stator segment 56 (FIG. 1) and at least one cooling channel 114 between the stator segments 56. The segmented cooling subsystem 112 may be equated to the segmented cooling subsystems 14 described above. The stator assembly 24 (FIG. 1) including multiple stator segments 56 enables access to regions 116 between the stator segments 56. Thus, cooling channels 114 disposed in such regions 116 enable improved cooling. The cooling channels 114 may be integral to the segmented cooling subsystem 112. In one embodiment, the cooling channel 114 directs airflow. In another embodiment, the cooling channel 114 directs liquid flow. Non-limiting examples of a coolant may include air and oil. Such a cooling arrangement provides cooling to the endwindings 77 and the regions 116 between the stator segments 56. In one embodiment, the segmented cooling channels 114 may solely be provided. In another embodiment, the segmented cooling channels 114 in combination with the segmented cooling subsystem 112 is provided. Non-limiting examples of material used in cooling channels 114 are copper, plastic and ceramics. In another embodiment, the cooling channels 114 are electrically insulated in case of a conducting coolant. It will be appreciated that the cooling channels may be of different shapes and sizes.

FIG. 7 is a front view of the electric machine 10 including the cooling arrangement of FIG. 6. As illustrated herein, the cooling channels 114 are disposed between the stator segments 56 to provide additional cooling. The airflow or liquid flow is guided along a centerline axis 122 of the electric machine 10.

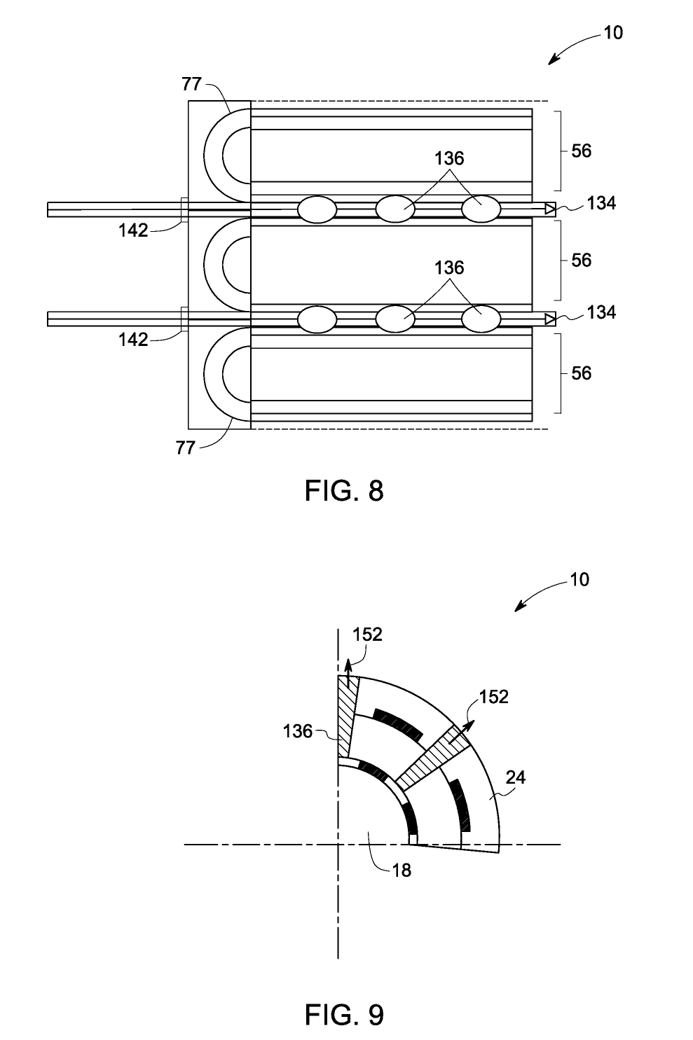

FIG. 8 is a top view of the electric machine 10 including a segmented cooling subsystem 132 attached to the stator segment 56 (FIG. 1) and at least one segmented cooling channel 134 including at least one segmented radial duct 136 between the stator segments 56. The segmented cooling subsystem 112 may be equated to the segmented cooling subsystems 14 described above. The ‘radial duct’ refers to a hole, channel or tube directed from an inner radius of the stator assembly 24 to an outer radius of the stator assembly 24. The segmented cooling subsystem 132 may be equated to the segmented cooling subsystems 14 described above. The stator assembly 24 (FIG. 1) including multiple stator segments 56 enables access to regions 116 between the stator segments 56. Thus, segmented cooling channels 134 including radial ducts 136 disposed in such regions 116 enable improved cooling.

The cooling channels 134 may be integral to the segmented cooling subsystem 114. In one embodiment, the cooling channel 134 directs airflow. In another embodiment, the cooling channel 134 directs liquid flow, such as, oil flow. Such a cooling arrangement provides cooling to the endwindings 77 and the regions 142 between the stator segments 56. In one embodiment, the cooling channels 134 including radial ducts 136 may solely be provided. In another embodiment, the cooling channels 134 including radial ducts 136 in combination with the cooling subsystem 114 is provided. Non-limiting examples of a coolant fluid may include air, water, ethylene glycol, propylene glycol and oil. In one embodiment, the segmented radial ducts 136 may be solely provided. In another embodiment, the segmented radial ducts 136 may be provided in combination with the segmented cooling channels 134.

FIG. 9 is a front or cross section view of the electric machine 10 including cooling arrangement in FIG. 8. The segmented radial ducts 136 direct fluid flow from the airgap 18 outward in a direction 152. Such a direction of fluid flow provides cooling to the stator assembly 24. Thus, such a cooling arrangement provides a radial cooling solution directed from an inner diameter to an outer diameter of the stator assembly 24. It should be noted that the radial duct 136 may penetrate the stator assembly 24 such that air flows radially outward through the stator assembly 24.

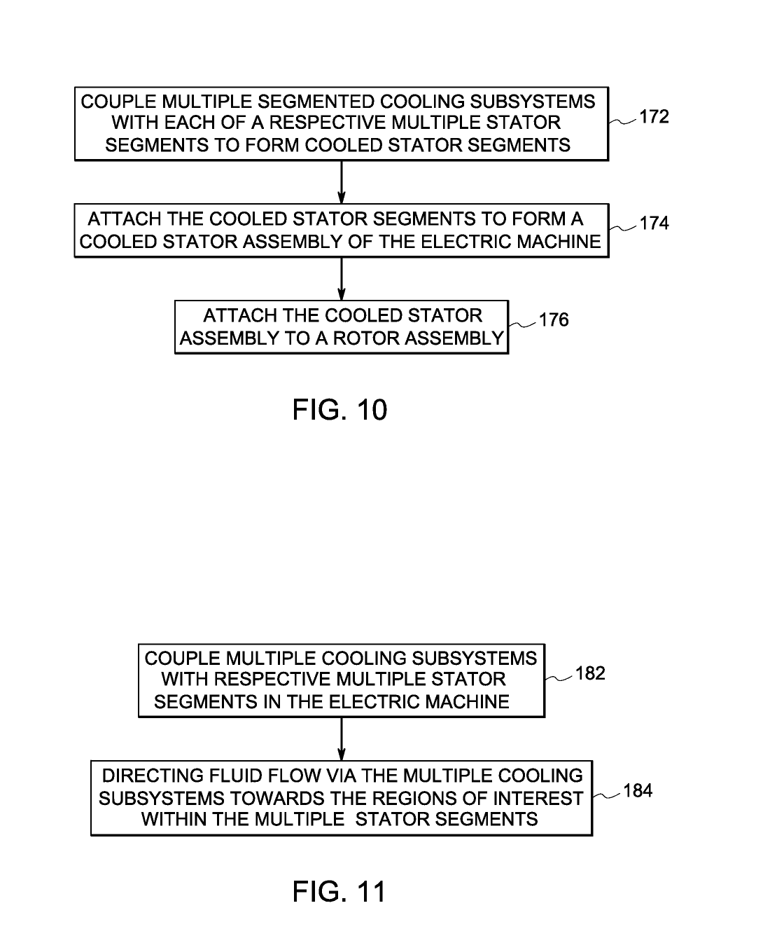

FIG. 10 is a flow chart representing steps in a method of assembly of an electric machine in accordance with an embodiment of the invention. The method includes coupling multiple segmented cooling subsystems with each of a respective multiple stator segments to form multiple cooled stator segments in step 172. The multiple cooled stator segments are attached to form a cooled stator assembly in step 174. The cooled stator assembly is attached to a rotor assembly in step 176.

FIG. 11 is a flow chart representing steps in a method for cooling regions of interest in an electric machine in accordance with an embodiment of the invention. The method includes coupling multiple cooling subsystems with respective multiple stator segments in the electric machine in step 182. Fluid flow is directed via multiple cooling subsystems towards the regions of interest within the multiple stator segments in step 184.

Electrical machines including segmented cooling subsystems coupled with multiple stator segments, as described above, may be employed in a variety of applications. One of them includes aviation applications, such as in aircraft engines. Particularly, the electrical machines may be a generator used for generating supplemental electrical power from a rotating member, such as a low pressure (LP) turbine spool, of a turbofan engine mounted on an aircraft. The electrical machines can also be used for other non-limiting examples such as traction applications, wind and gas turbines, starter-generators for aerospace or automotive applications, industrial applications and appliances.

The various embodiments of an electrical machine including a segmented cooling system described above thus provide a way to provide efficient cooling that allows for an electrical machine with high power density, reliability and fault tolerance. The segmented cooling system in combination with segmented stator segments allows for manufacturing of smaller size electric machines with desirable power density. The technique also allow for a much simpler and convenient assembly. Furthermore, the techniques and systems provide an innovative thermal management arrangement and also allow for highly efficient electrical machines.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of an impingement cooling system described with respect to one embodiment can be adapted for use with a cooling channel with radial ducts described with respect to another. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A segmented cooling system for an electric machine comprising:
a plurality of cooling subsystems coupled to respective plurality of separate stator segments coupled together in the electric machine, wherein the plurality of cooling subsystems is configured to direct fluid flow towards one or more regions of interest within the respective plurality of separate stator segments.

2. The cooling system of claim 1, wherein the plurality of cooling subsystems comprise at least one baffle.

3. The cooling system of claim 1, wherein the plurality of cooling subsystems comprise an impingement nozzle.

4. The cooling system of claim 3, wherein the impingement nozzle is configured to direct a flow of the fluid.

5. The cooling system of claim 1, wherein the plurality of cooling subsystems comprise a spray nozzle.

6. The cooling system of claim 1, wherein the plurality of cooling subsystems comprises one or more axial cooling channels disposed between the respective plurality of separate stator segments.

7. The cooling system of claim 6, wherein the cooling channels comprise at least one radial duct configured to guide the fluid flow in a radial direction within each of the respective plurality of separate stator segments.

8. The cooling system of claim 1, wherein the fluid comprises one or more compatible coolant fluids, the coolant fluids comprising air and oil.

9. An electric machine comprising:
a stator comprising:
a plurality of separate stator segments coupled to a respective plurality of cooling subsystems; wherein the plurality of separate stator segments are coupled together to form a cooled stator assembly; wherein the plurality of cooling subsystems is configured to direct fluid flow towards one or more regions of interest within the respective plurality of separate stator segments; and
a rotor comprising a rotor core, the rotor disposed concentrically either inside or outside of the stator.

10. The electric machine of claim 9, wherein the plurality of cooling subsystems comprise at least one baffle.

11. The electric machine of claim 9, wherein the plurality of cooling subsystems comprise an impingement nozzle.

12. The electric machine of claim 11, wherein the impingement nozzle is configured to direct a flow of the fluid.

13. The electric machine of claim 9, wherein the plurality of cooling subsystems comprise a spray nozzle.

14. The electric machine of claim 9, wherein the plurality of cooling subsystems comprises one or more cooling channels disposed between the respective plurality of separate stator segments.

15. The electric machine of claim 9, wherein the cooling channels comprise at least one radial duct configured to guide the fluid flow in a radial direction within each of the respective plurality of separate stator segments.

16. The electric machine of claim 9, wherein the fluid comprises air, oil, ethylene glycol, propylene glycol and water.

17. A method of assembly of an electric machine, the method comprising:
coupling a plurality of segmented cooling subsystems with each of a respective plurality of separate stator segments to form a plurality of separate cooled stator segments;
attaching the plurality of separate cooled stator segments to form a cooled stator assembly of the electric machine; and
attaching the cooled stator assembly to a rotor assembly.

18. A method for cooling regions of interest in an electric machine, the method comprising:
coupling a plurality of cooling subsystems with respective plurality of separate stator segments in the electric machine; wherein the plurality of separate stator segments are coupled together to form a cooled stator assembly; and
directing fluid flow via the plurality of cooling subsystems towards the regions of interest within the plurality of separate stator segments.
